(19) United States
(12) Patent Application Publication
(10) Pub. No.: US 2019/0017537 A1
(43) Pub. Date: Jan. 17, 2019

(54) DRIVE SHAFT INTERFACE FOR A PICK-UP REEL OF A COMBINE HARVESTER

(71) Applicant: HCC, INC., Mendota, IL (US)

(72) Inventor: Jeffrey Harris Maney, Rockford, IL (US)

(21) Appl. No.: 16/005,203

(22) Filed: Jun. 11, 2018

Related U.S. Application Data
(60) Provisional application No. 62/533,237, filed on Jul. 17, 2017.

(51) Int. Cl. F16C 3/02; A01D 57/02

(52) U.S. Cl. CPC F16C 3/023; A01D 57/02

(57) ABSTRACT

An improved drive shaft interface which yields increased strength, lower cost, and lighter weight. Preferably, the improved drive shaft interface is in the form of a corniform geometry which provides for stress translation to hoop stress vs. pure bending stress, thereby increasing the overall resistance to failure. This geometry also allows for a hollow construction, thereby providing for reduced weight compared to the prior art construction. Additionally, manufacturing processes can be employed—such as metal spinning, metal forming, friction welding, casting and post machining, etc.—which can yield a lower cost component.

### RELATED APPLICATION (PRIORITY CLAIM)

This application claims the benefit of U.S. Provisional Application Ser. No. 62/533,237, filed Jul. 17, 2017, which is hereby incorporated herein by reference in its entirety.

### BACKGROUND

The present invention generally relates to combine harvester header pick up reels, and more specifically relates to an improved drive shaft interface for a pick-up reel of a combine harvester.

As shown in FIG. 1, a typical combine grain harvester header 10 includes a pick-up reel 12. The pick-up reel 12 includes a plurality of bat tubes 14, and tines 16 are arranged along each of the bat tubes 14. When the pick-up reel 12 rotates, the tines 16 engage the crop and pull the crop into the header 10.

Typically, each bat tube 14 is supported by a reel arm 18, and each bat tube support arm 18 is connected to a center support tube 20. As shown in FIG. 2, a drive shaft 22 is connected to each end of the center tube 20, wherein one of the drive shafts 22 effectively operates as the drive shaft while the other acts merely as an idler, wherein the drive shaft drives the pick-up reel 12 and causes it to rotate. As shown in FIGS. 2 and 3, the prior art drive shaft construction 22 consists of two spaced-apart plates 24, 26 which are disposed on a shaft 30. FIG. 3 illustrates the prior art drive shaft construction 22 installed on an end of the center tube 20. As shown, the one plate 26 is disposed inside the center tube 20 while the other plate, specifically a formed flange plate 24, is mechanically connected to the center tube 20. As shown in FIGS. 2 and 3, anchor tabs 32 are welded onto the center tube 20, and (as shown in FIG. 3) it is these anchor tabs 32 to which the formed flange plate 24 is connected, such as via fasteners 34—one of which is depicted in FIG. 3. A current alternative to the anchor tab construction is a circular ring welded to the center tube 20, to which the formed flange plate 24 is mechanically connected via fasteners.

While this construction has proven sufficient for small, older pick-up reels which operate at relatively slow speeds, modern pick-up reels are larger and faster, rendering the prior art drive shaft construction inadequate. Specifically, oftentimes the formed flange plate 24—i.e., the plate which is connected to the center tube 20—fails. In an attempt to render the prior art shaft construction adequate for modern pick-up reels, methods of strengthening have been applied to the formed flange plate. This has resulted in increased cost and added weight, yet has not resulted in adequate increased factors of safety due to unknown field conditions (i.e., unpredictable loading experienced during operation).

### SUMMARY

An object of an embodiment of the present invention is to provide an improved drive shaft interface for a pick-up reel of a combine harvester.

Briefly, an embodiment of the present invention provides an improved drive shaft interface which yields increased strength, lower cost, and lighter weight. In a preferred embodiment, the improved drive shaft interface is in the form of a corniform geometry which provides for stress translation to hoop stress vs. pure bending stress, thereby increasing the overall resistance to failure. This geometry also allows for a hollow construction, thereby providing for reduced weight compared to the prior art construction. Additionally, manufacturing processes can be employed—such as metal spinning, metal forming, friction welding, casting and post machining, etc.—which can yield a lower cost component.

### BRIEF DESCRIPTION OF THE DRAWINGS

The organization and manner of the structure and operation of the invention, together with further objects and advantages thereof, may best be understood by reference to the following description taken in connection with the accompanying drawings wherein like reference numerals identify like elements in which:

FIG. 1 illustrates a conventional pick-up reel and combine harvester header;

FIG. 2 illustrates prior art drive shafts disposed at ends of a center tube of the pick-up reel of FIG. 1;

FIG. 3 illustrates how a prior art drive shaft connects to the end of the center tube of the pick-up reel of FIG. 1;

FIG. 4 is a cross-sectional view showing a drive shaft construction connected to each end of a center tube of a pick-up reel, wherein each construction is in accordance with an embodiment of the present invention;

FIG. 5 is a close up view of an end of the center tube shown in FIG. 4, showing a plug engaged with the end of the drive shaft construction;

FIG. 6 is an end view of the drive shaft shown in FIG. 4;

FIG. 7 is a side view showing the drive shaft of FIG. 5 connected to the end of the center tube of a pick-up reel of a combine harvester header;

FIG. 8 is similar to FIG. 7, but provides a perspective view; and

FIGS. 9, 10 and 11 illustrate an alternative embodiment.

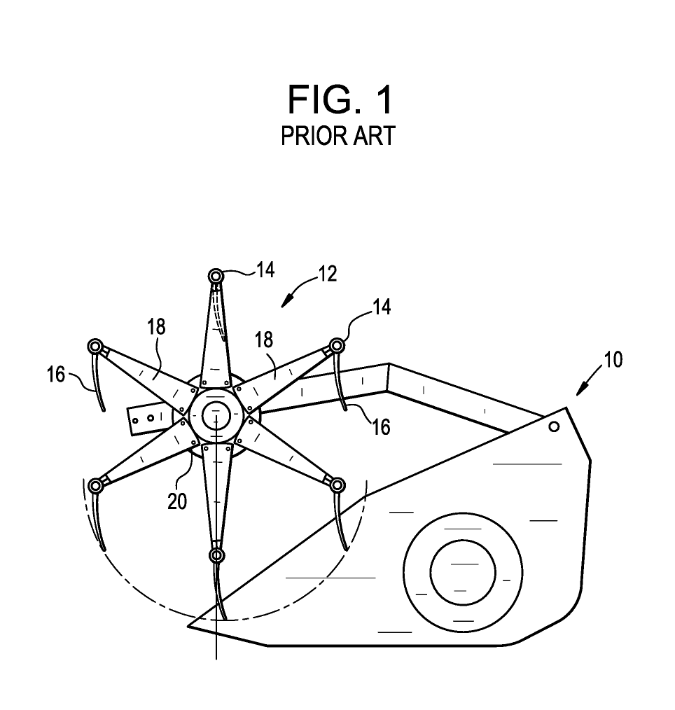

### DESCRIPTION OF ILLUSTRATED EMBODIMENTS

While this invention may be susceptible to embodiment in different forms, there are shown in the drawings and will be described herein in detail, specific embodiments with the understanding that the present disclosure is to be considered an exemplification of the principles of the invention, and is not intended to limit the invention to that as illustrated.

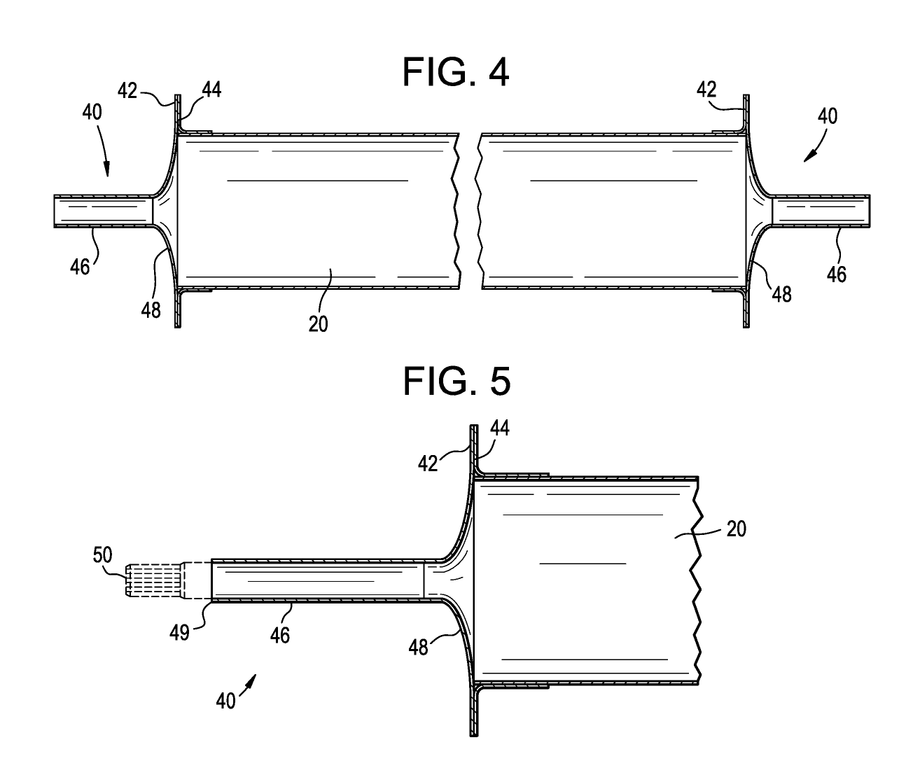

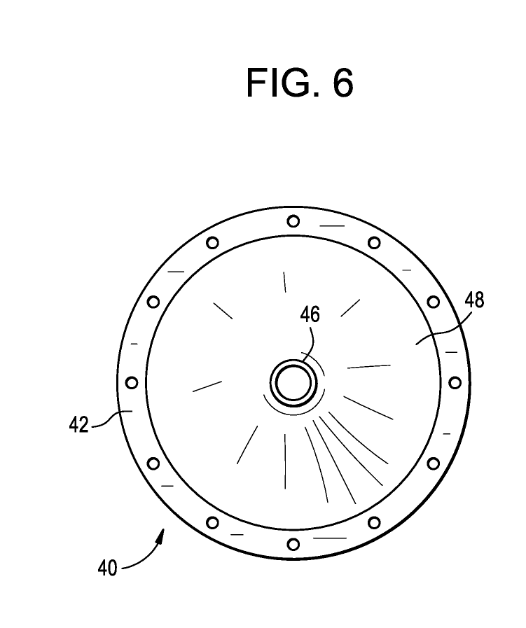

FIG. 4 is a cross-sectional view showing a drive shaft construction 40 connected to each end of a center tube 20 of a pick-up reel, wherein each construction 40 is in accordance with an embodiment of the present invention. FIG. 5 is a close up view of an end of the center tube 20 shown in FIG. 4, showing a plug 50 engaged with the end 49 of the drive shaft construction 40. FIG. 6 is an end view of the drive shaft shown in FIG. 4. Preferably, the drive shaft construction 40 comprises a single piece which is bolted or otherwise connected to the center tube 20.

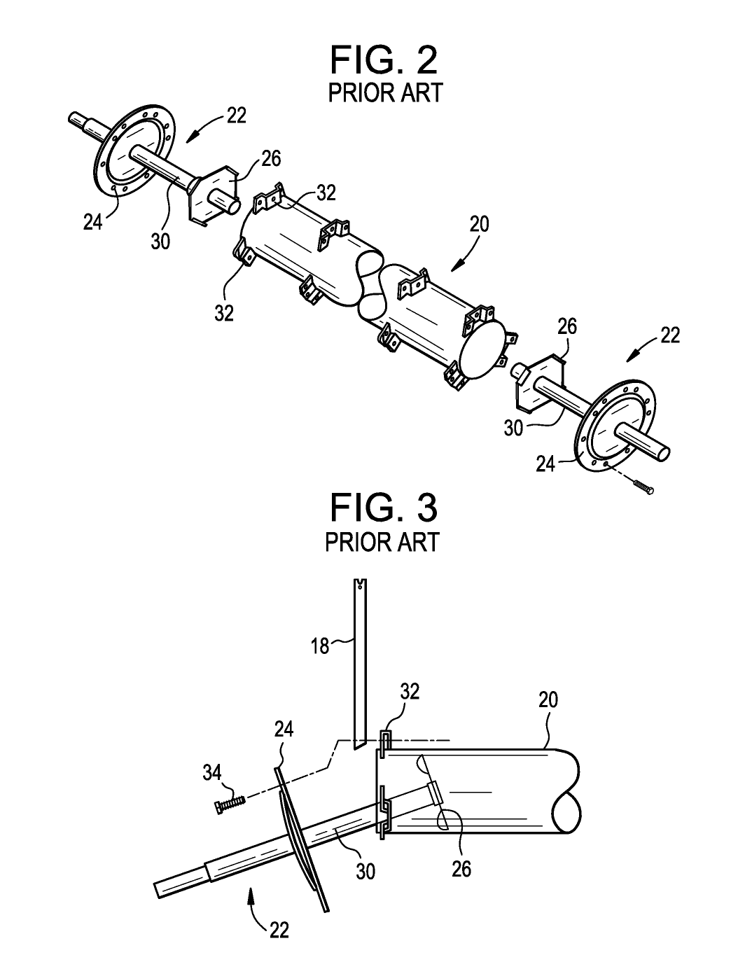

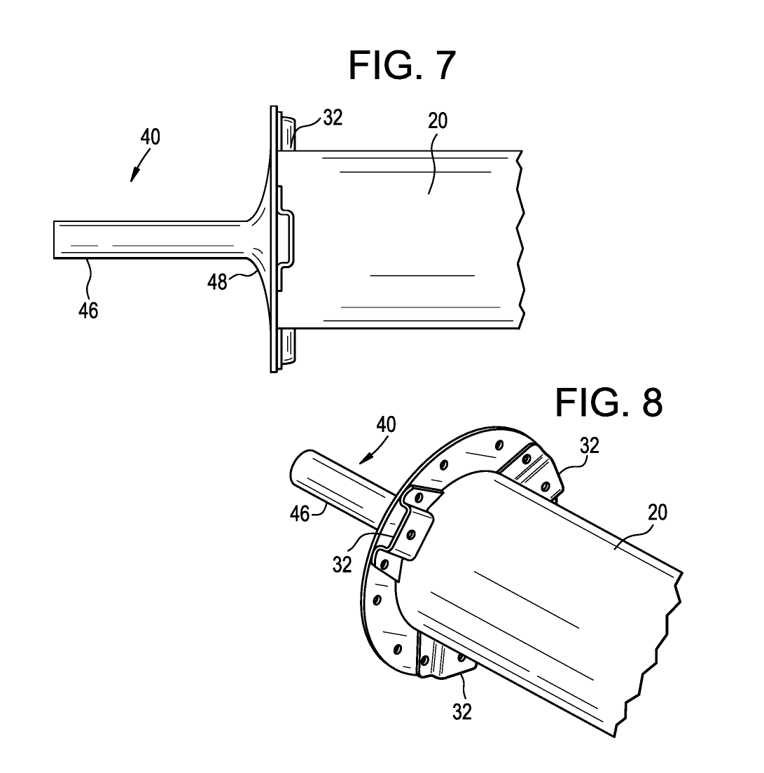

As shown in FIGS. 4-8, preferably the drive shaft construction 40 has a formed flange or ring portion 42 at its end, for securing to the center tube 20. Preferably (although not required), the center tube 20 has a corresponding formed flange or formed ring 44 thereon to which the formed flange 42 of the drive shaft construction 40 connects. Alternatively, the drive shaft construction 40 can be connected to anchor tabs 32 which exist on a conventional pick-up reel center tube 20 (see FIGS. 2, 3, 7 and 8).

As shown in FIGS. 4 and 5, the drive shaft construction 40 may, for example, comprise a single piece spun shaft casing. Of course, the drive shaft construction 40 can take other forms while staying well within the scope of the present invention, such as being either a formed piece or a casting. Preferably, the drive shaft construction 40 is tubular, comprising a hollow shaft portion 46 and a funnel corniform section 48, thereby providing decreased weight. Preferably, a similar drive shaft construction 40 is installed at each end of the center tube 20 with one drive shaft construction acting as the driver and the other drive shaft acting merely as an idler (i.e., a driven shaft). Regarding the end that acts as the driver, preferably (as shown in FIG. 5) a plug 50 is welded or otherwise connected to an end 49 of the drive shaft construction 40 and is configured to mate with the driving mechanism (e.g., holes, splines, D-drive, etc.) which works to effectively drive the pick-up reel during operation.

With regard to manufacturing, the drive shaft construction 40 can be manufactured via several different methods, such as one piece metal spun shaft, two pieces consisting of a metal spun section or formed metal section (stamping) and a tube in a welded configuration, one piece via casting and post process machining, etc. The drive shaft construction 40 can also be either a formed piece or a casting.

The drive shaft construction 40 provides an improved drive shaft interface which yields increased strength, lower cost, and lighter weight. As shown, a portion 48 of the drive shaft construction 40 is in the form of a corniform geometry which provides for stress translation to hoop stress vs. pure bending stress, thereby increasing the overall resistance to failure. This geometry also allows for a hollow construction, thereby providing for reduced weight compared to the prior art construction. Additionally, manufacturing processes can be employed—such as metal spinning, metal forming (stamping), friction welding, casting and post machining, etc.—which can provide for decreased manufacturing costs.

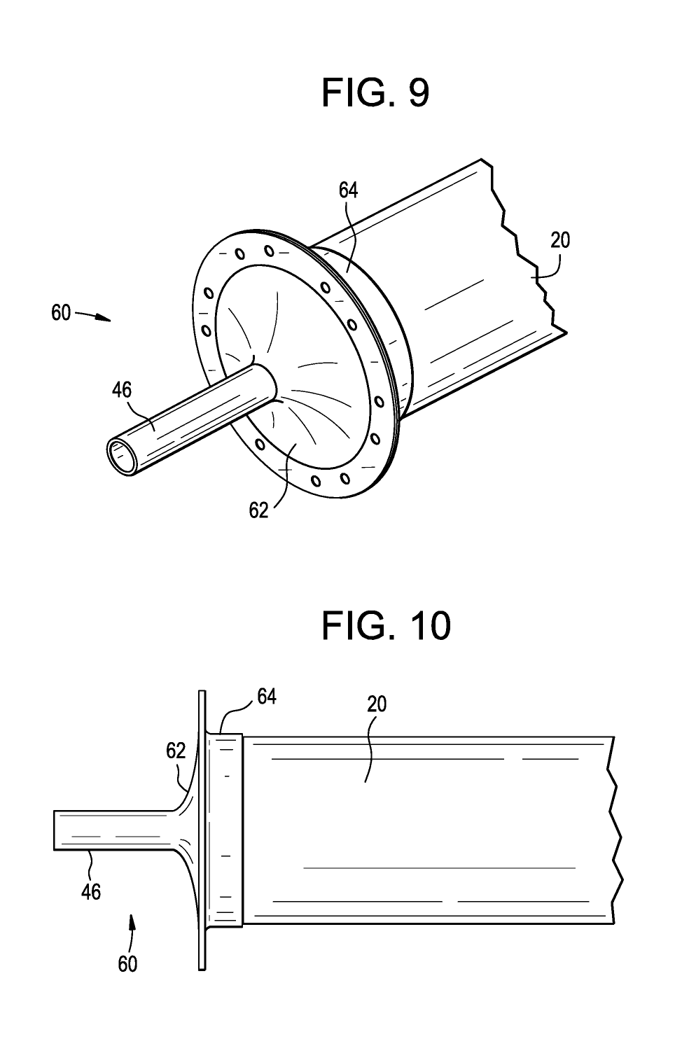

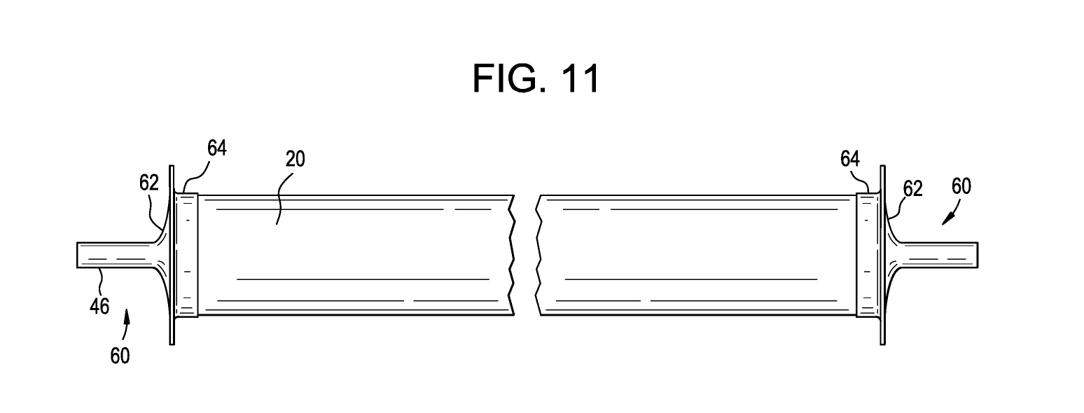

FIGS. 9, 10 and 11 illustrate a drive shaft construction 60 which is in accordance with an alternative embodiment. The drive shaft construction 60 has a hollow shaft portion 46 and a corniform geometry flange 62 at its end, much like the previous embodiment 40. But the corniform geometry flange 62 mates with a corresponding formed ring or flange 64 which is disposed on the center tube 20. This connection is more reliable and provides greater integrity than a mere connection to anchor tabs such as is provided in the prior art.

While specific embodiments of the invention have been shown and described, it is envisioned that those skilled in the art may devise various modifications without departing from the spirit and scope of the present invention.

What is claimed is:

1. A pick-up reel comprising: a center tube having an end; and a drive shaft construction engaged with the end of the center tube, said drive shaft construction comprising a hollow shaft portion and a funnel corniform section.

2. A pick-up reel as recited in claim 1, wherein the hollow shaft portion and the funnel corniform section comprise a single piece.

3. A pick-up reel as recited in claim 1, further comprising a plug which is engaged with the hollow shaft portion of the drive shaft construction.

4. A pick-up reel as recited in claim 1, said drive shaft construction comprising a formed flange, wherein said formed flange is engaged with the center tube.

5. A pick-up reel as recited in claim 1, wherein the drive shaft construction comprises an end, further comprising a plug which is connected to the end of the drive shaft construction and which is configured to mate with a driving mechanism that drives the pick-up reel during operation.

6. A pick-up reel as recited in claim 1, wherein the drive shaft construction comprises either a formed piece or a casting.

7. A pick-up reel as recited in claim 1, wherein the drive shaft construction is tubular.

8. A pick-up reel as recited in claim 1, wherein a drive shaft construction is installed at each end of the center tube with one drive shaft construction acting as the driver and the other drive shaft acting merely as an idler.

9. A pick-up reel as recited in claim 8, wherein a plug is connected to the end of the drive shaft construction which acts as the driver and is configured to mate with a driving mechanism which works to drive the pick-up reel during operation.

10. A pick-up reel as recited in claim 1, further comprising a formed flange on the center tube, wherein the funnel corniform section of the drive shaft construction engages the formed flange on the center tube.

11. A pick-up reel as recited in claim 1, wherein the hollow shaft portion and the funnel corniform section comprise either a formed piece or a casting that is tubular, wherein the drive shaft construction comprises a formed flange which is engaged with the center tube.

12. A pick-up reel as recited in claim 11, further comprising a plug which is engaged with the hollow shaft portion of the drive shaft construction.

13. A pick-up reel as recited in claim 11, wherein the drive shaft construction comprises either a formed piece or a casting.

14. A pick-up reel as recited in claim 11, wherein a drive shaft construction is installed at each end of the center tube with one drive shaft construction acting as the driver and the other drive shaft acting merely as an idler.

15. A pick-up reel as recited in claim 14, wherein a plug is connected to the end of the drive shaft construction which acts as the driver and is configured to mate with a driving mechanism which works to drive the pick-up reel during operation.
